(19) United States
(12) Patent Application Publication
(10) Pub. No.: US 2006/0101434 A1
(43) Pub. Date: May 11, 2006

(54) Reducing register file bandwidth using bypass logic control

(76) Inventors: Adam Lake, Portland, OR (US); Chris Wilkerson, Portland, OR (US); Carl S. Marshall, Portland, OR (US); Daniel E. Johnston, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/955,873

(22) Filed: Sep. 30, 2004

(51) Int. Cl. G06F 9/45

(52) U.S. Cl. 717/140

(57) ABSTRACT

A method, apparatus, and system are provided for reducing register file bandwidth using bypass logic control. According to one embodiment, a source code is translated into an intermediate code, which is then to be translated into an executable code. A bypass control logic description file is accessed to perform a lookup of description information at the description file. The description information is then used to compile the intermediate code into the executable.

### BACKGROUND

1. Field of the Invention

Embodiment of this invention relate generally to processors. More particularly, an embodiment of the present invention relates to a mechanism for reducing register file bandwidth in a microprocessor operating within a managed run-time environment (MRTE) using bypass logic control (BLC).

2. Description of Related Art

In many multithreaded and complex programs, large sets of data are loaded into registers, combined with permanent data also contained in registers, and written back to memory in a loop fashion. Typically, available registers are not enough to contain all necessary permanent data in addition to temporary loop data. This results in permanent data being written to memory and loaded back into registers upon each iteration of the loop. However, such process is slow as it increases the memory traffic and reduces processor efficiency. One solution to the problem is to increase the number of registers residing in a processor to perform various tasks (e.g., writing and reading of information). Because the result is to be explicitly written and read from registers, having a greater number of registers reduces the number of spills into the memory hierarchy, which in turn increases processor performance. However, the greater and bigger the registers, the more power and valuable processor space they consume and the slower they become.

Furthermore, today's processors with multiple execution pipelines require reading from and writing to multiple registers in the register file at the same time through different ports. The implementation of multiple read and write ports into the register file can be expensive and space consuming. Typically, the register file size grows in proportion of square with the number of ports. For example, doubling the number of ports increases the size of a register file four times. The conventional solution of increasing the number of registers, including using a high number of ports and the frequency of using such ports, is expensive, inefficient, slow, takes up valuable space, and creates unnecessary complexity in the processor.

### BRIEF DESCRIPTION OF THE DRAWINGS

The appended claims set forth the features of the embodiments of the present invention with particularity. The embodiments of the present invention, together with its advantages, may be best understood from the following detailed description taken in conjunction with the accompanying drawings of which:

FIG. 1 is a block diagram illustrating an exemplary computer system used in implementing one or more embodiments of the present invention;

FIG. 2 is a block diagram illustrating an embodiment of an architecture 200 having bypass control logic, a compiler, and an execution pipeline;

FIG. 3 is a block diagram illustrating an embodiment of an architecture having bypass control logic, a compiler, and various execution pipelines;

FIG. 4 is a table illustrating an embodiment of a sequence of instructions showing a comparison between a scheduled code and a transformed code; and

FIG. 5 is a table illustrating an embodiment of instruction encoding in an instruction set architecture; and

FIG. 6 is a block diagram illustrating an embodiment of a process for using bypass logic with a compiler.

### DETAILED DESCRIPTION

Described below is a system and method for reducing register file bandwidth in a managed run-time environment (MRTE). Throughout the description, for the purposes of explanation, numerous specific details are set forth in order to provide a thorough understanding of the embodiments of the present invention. It will be apparent, however, to one skilled in the art that the present invention may be practiced without some of these specific details. In other instances, well-known structures and devices are shown in block diagram form to avoid obscuring the underlying principles of the present invention.

In the following description, numerous specific details such as logic implementations, opcodes, resource partitioning, resource sharing, and resource duplication implementations, types and interrelationships of system components, and logic partitioning/integration choices may be set forth in order to provide a more thorough understanding of various embodiments of the present invention. It will be appreciated, however, to one skilled in the art that the embodiments of the present invention may be practiced without such specific details, based on the disclosure provided. In other instances, control structures, gate level circuits and full software instruction sequences have not been shown in detail in order not to obscure the invention. Those of ordinary skill in the art, with the included descriptions, will be able to implement appropriate functionality without undue experimentation.

Various embodiments of the present invention will be described below. The various embodiments may be performed by hardware components or may be embodied in machine-executable instructions, which may be used to cause a general-purpose or special-purpose processor or a machine or logic circuits programmed with the instructions to perform the various embodiments. Alternatively, the various embodiments may be performed by a combination of hardware and software.

Various embodiments of the present invention may be provided as a computer program product, which may include a machine-readable medium having stored thereon instructions, which may be used to program a computer (or other electronic devices) to perform a process according to various embodiments of the present invention. The machine-readable medium may include, but is not limited to, floppy diskette, optical disk, compact disk-read-only memory (CD-ROM), magneto-optical disk, read-only memory (ROM) random access memory (RAM), erasable programmable read-only memory (EPROM), electrically erasable programmable read-only memory (EEPROM), magnetic or optical card, flash memory, or another type of media/machine-readable medium suitable for storing electronic instructions. Moreover, various embodiments of the present invention may also be downloaded as a computer program product, wherein the program may be transferred from a remote computer to a requesting computer by way of data signals embodied in a carrier wave or other propagation medium via a communication link (e.g., a modem or network connection).

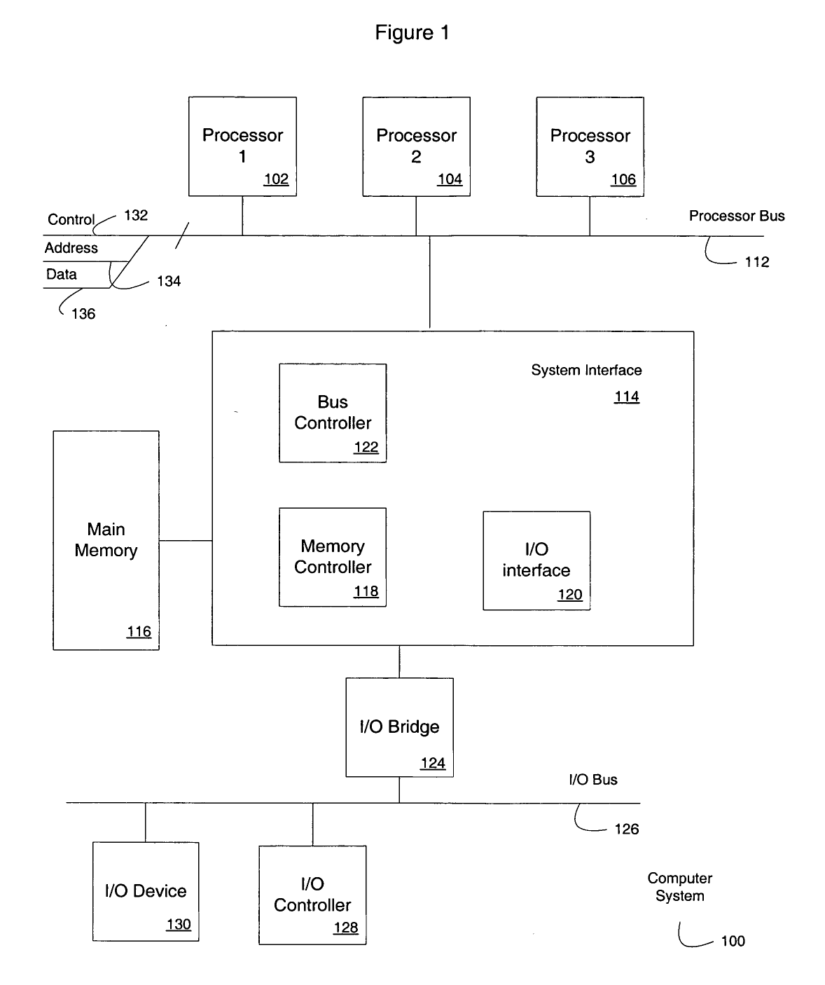

FIG. 1 is a block diagram illustrating an exemplary computer system 100 used in implementing one or more embodiments of the present invention. The computer system (system) includes one or more processors 102-106. The processors 102-106 may include one or more single-threaded or multi-threaded processors. A typical multi-threaded processor may include multiple threads or logical processors, and may be capable of processing multiple instruction sequences concurrently using its multiple threads. Processors 102-106 may also include one or more internal levels of cache (not shown) and a bus controller or bus interface unit to direct interaction with the processor bus 112.

Processor bus 112, also known as the host bus or the front side bus, may be used to couple the processors 102-106 with the system interface 114. Processor bus 112 may include a control bus 132, an address bus 134, and a data bus 136. The control bus 132, the address bus 134, and the data bus 136 may be multidrop bi-directional buses, e.g., connected to three or more bus agents, as opposed to a point-to-point bus, which may be connected only between two bus agents.

System interface 114 (or chipset) may be connected to the processor bus 112 to interface other components of the system 100 with the processor bus 112. For example, system interface 114 may include a memory controller 118 for interfacing a main memory 116 with the processor bus 112. The main memory 116 typically includes one or more memory cards and a control circuit (not shown). System interface 114 may also include an input/output (I/0) interface 120 to interface one or more I/O bridges or I/O devices with the processor bus 112. For example, as illustrated, the I/O interface 120 may interface an I/O bridge 124 with the processor bus 112. I/O bridge 124 may operate as a bus bridge to interface between the system interface 114 and an I/O bus 126. One or more I/O controllers and/or I/O devices may be connected with the I/O bus 126, such as I/O controller 128 and I/O device 130, as illustrated. I/O bus 126 may include a peripheral component interconnect (PCI) bus or other type of I/O bus.

System 100 may include a dynamic storage device, referred to as main memory 116, or a random access memory (RAM) or other devices coupled to the processor bus 112 for storing information and instructions to be executed by the processors 102-106. Main memory 116 also may be used for storing temporary variables or other intermediate information during execution of instructions by the processors 102-106. System 100 may include a read only memory (ROM) and/or other static storage device coupled to the processor bus 112 for storing static information and instructions for the processors 102-106.

Main memory 116 or dynamic storage device may include a magnetic disk or an optical disc for storing information and instructions. I/O device 130 may include a display device (not shown), such as a cathode ray tube (CRT) or liquid crystal display (LCD), for displaying information to an end user. For example, graphical and/or textual indications of installation status, time remaining in the trial period, and other information may be presented to the prospective purchaser on the display device. I/O device 130 may also include an input device (not shown), such as an alphanumeric input device, including alphanumeric and other keys for communicating information and/or command selections to the processors 102-106. Another type of user input device includes cursor control, such as a mouse, a trackball, or cursor direction keys for communicating direction information and command selections to the processors 102-106 and for controlling cursor movement on the display device.

System 100 may also include a communication device (not shown), such as a modem, a network interface card, or other well-known interface devices, such as those used for coupling to Ethernet, token ring, or other types of physical attachment for purposes of providing a communication link to support a local or wide area network, for example. Stated differently, the system 100 may be coupled with a number of clients and/or servers via a conventional network infrastructure, such as a company's Intranet and/or the Internet, for example.

It is appreciated that a lesser or more equipped system than the example described above may be desirable for certain implementations. Therefore, the configuration of system 100 may vary from implementation to implementation depending upon numerous factors, such as price constraints, performance requirements, technological improvements, and/or other circumstances.

It should be noted that, while the embodiments described herein may be performed under the control of a programmed processor, such as processors 102-106, in alternative embodiments, the embodiments may be fully or partially implemented by any programmable or hardcoded logic, such as field programmable gate arrays (FPGAs), transistor transistor logic (TTL) logic, or application specific integrated circuits (ASICs). Additionally, the embodiments of the present invention may be performed by any combination of programmed general-purpose computer components and/or custom hardware components. Therefore, nothing disclosed herein should be construed as limiting the various embodiments of the present invention to a particular embodiment wherein the recited embodiments may be performed by a specific combination of hardware components.

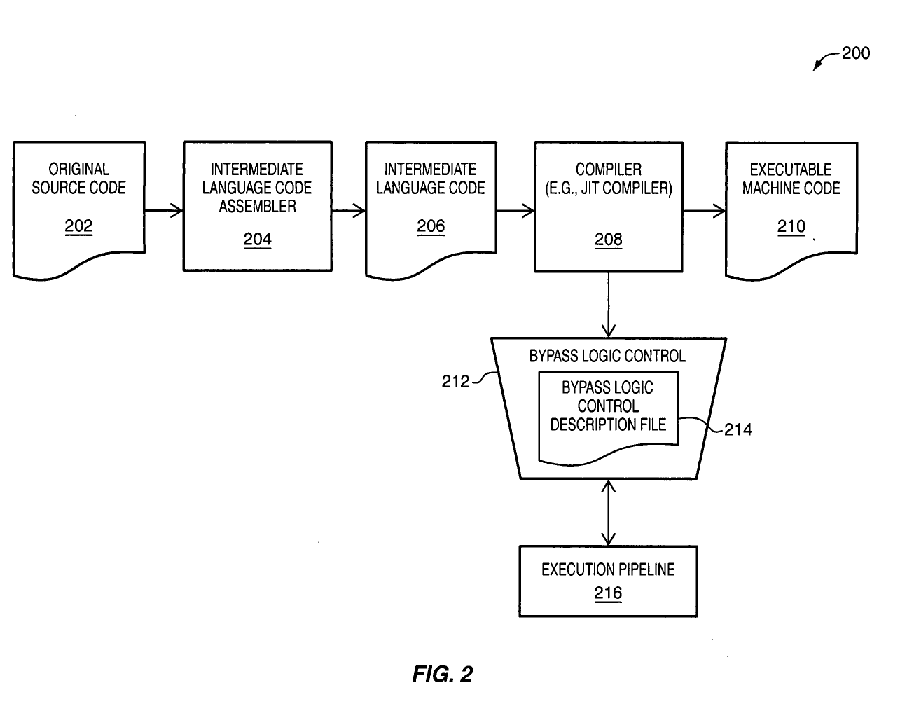

FIG. 2 is a block diagram illustrating an embodiment of an architecture 200 having bypass control logic 212, a compiler 208, and an execution pipeline 216. As illustrated, in an MRTE framework of the architecture 200, the original source file (program code or source code) 202 is read by an intermediate language assembler (assembler) 204 (e.g., Java assembler) to translate the source file 202 into an intermediate language representation or file (intermediate code) 206. To compile the high-level language or source code into the intermediate code 206 refers to having a computer program from any number of languages (e.g., Basic, C, C#) compiled into the same intermediate code 206 to be further converted into the executable code (native code or machine code) 210. For example, a virtual machine (VM) may be mapped via a compiler (e.g., Just-In-Time (JIT) compiler) 208 to further compile the intermediate code 206 into the executable code 210. The JIT compiler is typically used for languages like Java and C# to help convert the intermediate code 206 into the native machine code 210 just before the program is run. The executable code 210 can be referred to as a contract between the software and hardware of a computer system.

Typically, program instructions are executed in an execution pipeline 216. As the instructions goes through the pipeline 216, there may be instructions later in the program that depend on the result of prior instructions for execution. Having an instruction wait for another instruction to go through the pipeline 216 may result in slow processing and inefficiency. To avoid this, bypass control logic (BCL or bypass logic or bypass network) 212 is used in combination with the execution pipeline 216 to have the result from one instruction skip from the end of a pipeline 216 to go back to a previous instruction stage in the pipeline 216 where another instruction may need it. For example, instruction 2 depends on the result from instruction 1, which is a couple of stages ahead of instruction 2. Using the bypass logic 212, once the results from instruction 1 are obtained, it is moved back to a previous stage in the pipeline 216 to be closer to instruction 2 to use.

As illustrated, in one embodiment, the bypass logic 212 is exposed to the compiler 212 for use. Stated differently, although the bypass logic 212 may be hardware-based (e.g., having a set of multiplexers or other such components) and used with the execution pipeline 216, in one embodiment, the bypass logic 212 is exposed to the compiler 208, such as the JIT compiler, to help the compiler 208 compile the intermediate code 206 into the executable code 210. Having access to the bypass logic 212 includes the compiler 208 having access to a description file 214 associated with the bypass logic 212. In one embodiment, the description file 214 contains description information of the various execution pipelines 216 for the compiler 208 to use. The description information may include information regarding the timing of how instructions flow in the pipeline 216, availability of the number of bypass latches per execution pipeline, and the number of execution pipelines, and the like. The description information in the description file 214 is defined during processor design 216. Such information can be extracted from the description file 214 by the compiler 208 (e.g., accept the information as input) by accessing the description file 214, as necessitated, without having to have the information written to or read from registers.

In one embodiment, having the bypass control logic 212 exposed to the compiler 208 helps reduce or eliminate the need for additional registers or allows the additional registers to be used for other purposes. The bypass control description file 214 may include a static piece of data documenting the internal micro-architecture of the processor, such as number of execution pipelines 216, number of states within each pipeline 216, and where (at what stage) the bypass latches are located for each pipeline 216. Furthermore, the reading of the information from the description file 214 by the compiler 208 increases the performance of the application code by utilizing the bypass latches in the execution pipeline 216. Also, by exposing the bypass logic 212 to the compiler 208, the exposure to the registers is increased, but the need for the registers is decreased, as additional registers for reading and writing of the information are not needed.

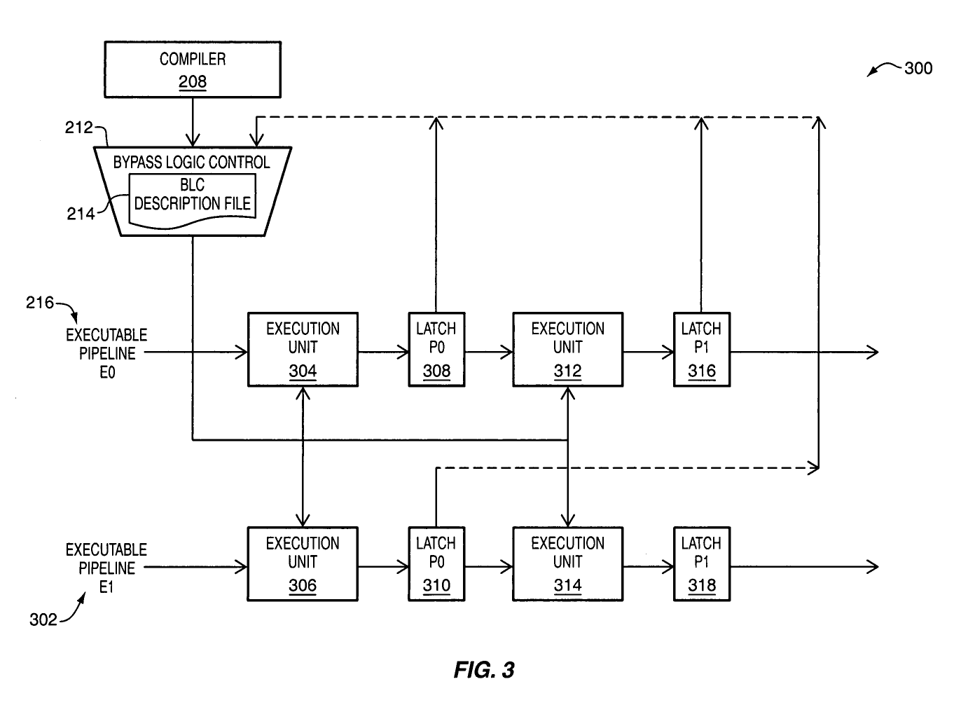

FIG. 3 is a block diagram illustrating an embodiment of an architecture 300 having bypass control logic 212, a compiler 208, and various execution pipelines 216, 302. In one embodiment, the architecture 300 includes two execution pipelines, the E0 pipeline 216 and the E1 pipeline 302. Each pipeline 216, 302 includes a number of execution units and latches. For example, as illustrated, the E0 pipeline 216 includes two execution units 304, 308 and two latches P0 308 and P1 316, while the E1 pipeline 302 includes two execution units 306, 314 and two latches P0 310 and P1 318. It is contemplated that the number of execution pipelines, execution units, and latches may vary from architecture to architecture.

In one embodiment, the architecture 300 further includes bypass logic 212 in exposed to the execution pipelines 216, 302. The description file 214 may include a static piece of data documenting the internal micro-architecture of the processor, such as number of execution pipelines 216, number of states within each pipeline 216, and where (at what stage) the bypass latches are located for each pipeline 216. Typically, a latch 308-310, 316-318 refers to an electronic circuit (e.g., flip flop) that alternates between two states. Here, the term latch is used as a generic term. Registers are made of latches 308-310, 316-318, having each pipeline stage being separated by latches. Here the latches 308-310, 316-318 in the execution pipeline 216, 302 are capable of being read by previous stages within the same or different execution pipeline 216, 302. The latches 308-310, 316-318 are also referred to as bypass ports.

As described with reference to FIG. 2, in one embodiment, the bypass logic 212 is further exposed to a compiler 208 which allows the compiler 208 to make use of the latches 308-310, 316-318 when scheduling instructions for execution. Having the latches 308-310, 316-318 exposed to the compiler 208, via the bypass logic 212, also reduces pressure on the register file and further reduces the need for registers and register reads and writes. Furthermore, the bandwidth requirement is decreased between various stages of the execution pipelines 216, 302. For example, if no instructions depend on the result of the another instruction, the instruction in flight can be retired and thus, further releasing resources that may have been consumed later in the pipeline 216, 302. The programmer may not be aware of any of the architectural modifications or functions.

In one embodiment, the bypass logic 212 includes a couple of levels to separately specify the execution results in the description file 214. For example, the first level may be used to specify the execution pipeline 216, 302 that contains the desired result, and the second level may be used to specify the stage of the already specified execution pipeline 216, 302 that contains the results. Furthermore, to uniquely specify a latch 308-310, 316-318 in the machine, the bypass logic 212 may be given a couple of coordinates, such as Ex or E to specify the execution pipeline 216, 302 having the results, and Py or P to specify the stage in the execution pipeline 216, 302 that contains the results. In other words, E refers to execution and P refers to pipeline stage. It is contemplated that any number of coordinates may be employed.

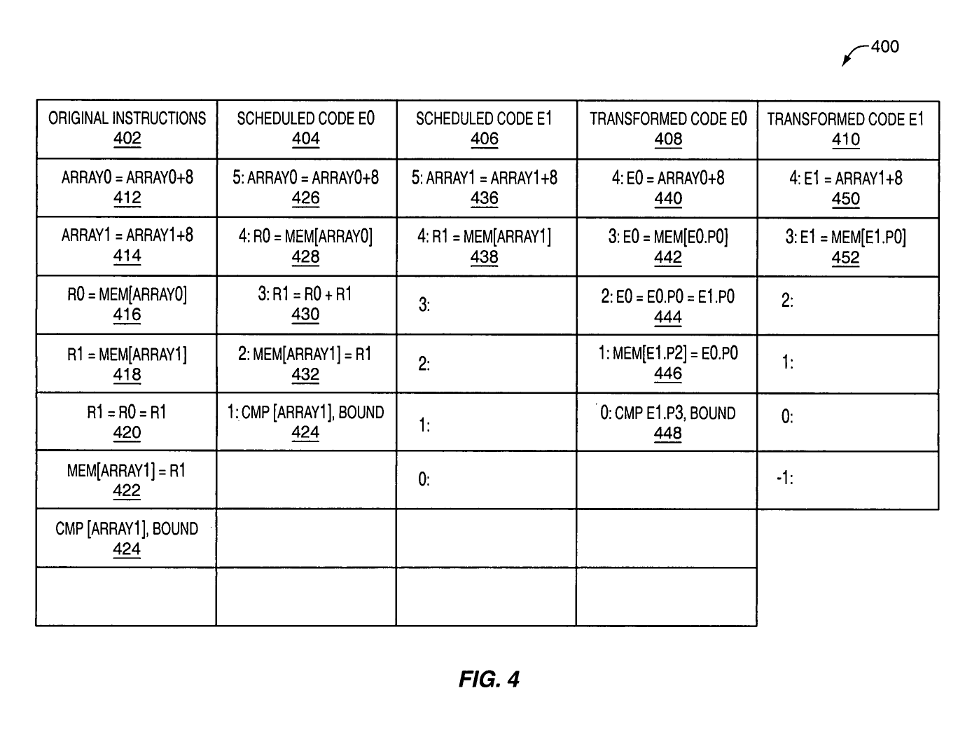

FIG. 4 is a table 400 illustrating an embodiment of a sequence of instructions 402 showing a comparison between a scheduled code 404, 406 and a transformed code 408, 410. As illustrated, the original instructions column 402 includes the sequence of instructions to be executed. In other words, original instructions 402 show a sequence of code in which the elements of two array (e.g., array 0, array 1) are added and written into array 1. Further, the original instructions column 402 depicts the original assembly produced by the compiler. For simplicity, the names of the variables (e.g., array 0, array 1, bound, etc.) are used instead of register identifier. It is contemplated that each of the variables may correspond to actual registers in the actual code.

The scheduled code columns (e.g., scheduled code E0 404 and scheduled code E1 406) illustrate how the instructions from original instructions 402 may be scheduled and divided between various execution pipelines. The transformed code columns (e.g., transformed code E0 408 and transformed code E1 410) show the result of the original instructions 402, as they differ from the scheduled code 404, 406, according to one embodiment. Stated differently, the transformed code 408, 410 depicts a version of the same sequence of instructions as original instructions 402, but these instructions are scheduled by a compiler having the awareness of the bypass logic and access to the bypass logic description file. The instructions are scheduled to run on a processor with two execution pipelines E0 and E1. Once the code has been scheduled, the compiler can determine where in the execution pipeline each instruction will be as the sequence code is processed. The compiler may then substitute register identifiers (e.g., array0, array1, R0 and R1) with bypass specifiers, indicating where in the bypass network the result can be found.

Now referring to the transformed code E0 408, it is to be noted that it does not require the register reads or writes of the scheduled code E0 404. This is because the transformed code E0 408 represents the compiler using data from the bypass logic description file to bypass the register reads and writes when scheduling original instructions 402. For example, the instructions array 0=array 0+8 412 and R0=mem[array0] 416 are taken from the original instructions column 402 and scheduled at the scheduled code column 404 as array0=array0+8 426 and R0=mem[array0] 428 which indicates the use of registers (e.g., R0) when using the scheduled code 404. In contrast, when using the transformed code E0 408, the instructions scheduled for the original instructions 412 and 416 are E0=array0+8 440 and E0=mem[E0.P0] 442. Transformed code instruction 440 signifies that an instruction is generated, but it is not necessarily written anywhere. The next instruction 442 signifies the address E0.P0 from which to take or load the result. The code E0 refers to execution pipeline 1, while P0 refers to pipeline stage (or latch) 1 (e.g., representing one cycle ago). Similarly E1, E2, . . . En refer to execution pipeline 2, execution pipeline 3 . . . execution pipeline n, while P1, P2 . . . Pn refer to stage 2, stage 3 . . . stage n. Stated differently, in the scheduled code E0 404 (e.g., for instruction R0=mem[array0] 428), the data is being loaded from the memory using the register file (e.g., R0) where the data was written. In one embodiment, in the transformed code E0 408 (e.g., for instruction E0=mem[E0.P0] 442), the address E0.P0 of the data is being provided (using the bypass logic description file) so that the data can be loaded from that address (e.g., execution pipeline E0, latch P0) without having to access any registers.

In one embodiment, instruction 444 (e.g., E0=E0.P0+E1.P0) of the transformed code E0 408 represents adding of the results from two addresses (e.g., E0.P0 and E1.P0) without needing or accessing any registers. In contrast, instruction 430 (e.g., R1=R0+R1) of the scheduled code 404 represents adding of the results loaded from two registers (e.g., R0 and R1). Referring now to instruction 446 (e.g., mem[E1.P2]=E0.P0), this instruction signifies storing the results from address execution pipeline E1 from 3 cycles ago (P2) using the address E0.P0. Instruction 446 is the counterpart of instruction 432 of the scheduled code E0 404 and, as illustrated, it uses a register (R1). The final instruction 448 of the transformed code E0 408 is a compare instruction (e.g., cmp E1.P3, bound). As illustrated, in one embodiment, using the transformed code E0 408 helps remove the need for the register file for register writes, and helps obtain data directly from the address by utilizing the compiler's access to the bypass logic description file.

In multi-threaded programs, threads switches are likely to occur dynamically and unpredictably at run-time. Also, processors regularly multi-task and each task is defined by the memory associated with that task and the data in the registers used in executing the task. However, when a processor switches the task, it loads the data from the registers to the memory and once it switches the task, the processor loads the data from the memory back into the registers and continues executing. In one embodiment, a checkpoint instruction (e.g., chkpt) can be used to avoid any potential problems when using multi-threaded programs and/or when a processor switches tasks between instructions (e.g., between instructions 442 and 444) in which case an address (e.g., E0.P0) may become invalid (by the time the processor switches back). The checkpoint instruction refers to a checkpoint or a boundary to monitor or divide the instructions. In one embodiment, instructions that succeed the checkpoint may not reference latched results of instructions that precede the checkpoint. Stated differently, instructions after the checkpoint may not use the bypass logic to load data referring to instructions before the checkpoint, and the processor when switching back from a task may start from where the checkpoint has occurred.

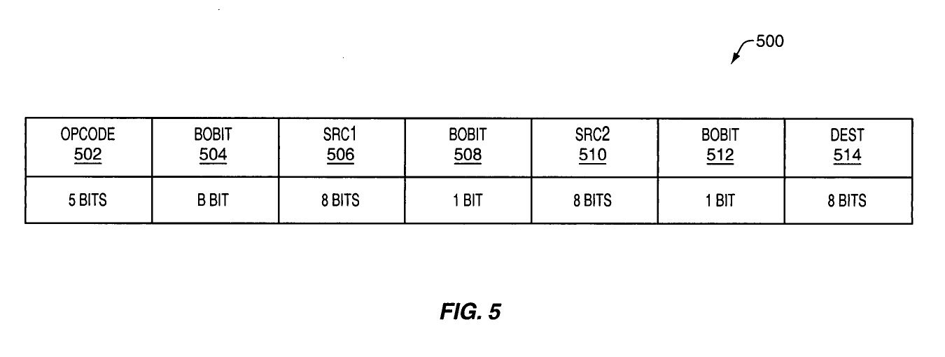

FIG. 5 is a table 500 illustrating an embodiment of instruction encoding in an instruction set architecture (ISA). In one embodiment, a single bit may be specified for source and destination to identify whether the source and destination refer to a slot in bypass control logic (e.g., P0, P1) or a register (e.g., R0, R1). Referring to table 500, the opcode 502 signifies the function of an instruction (e.g., add, subtract, etc.). The bypass override bit (BOBit) 504 associated with source 1 (src1) 506 is to signify the address of src1 504. For example, the BOBit 504 of zero indicates that src1 506 refers to a register address. If the BOBit 504 is 1, it may signify that 8 bits of src1 506 refer to a latch in the bypass network. Similarly, BOBits 508 and 512 identify the addresses of src2 510 and dest 514, respectively.

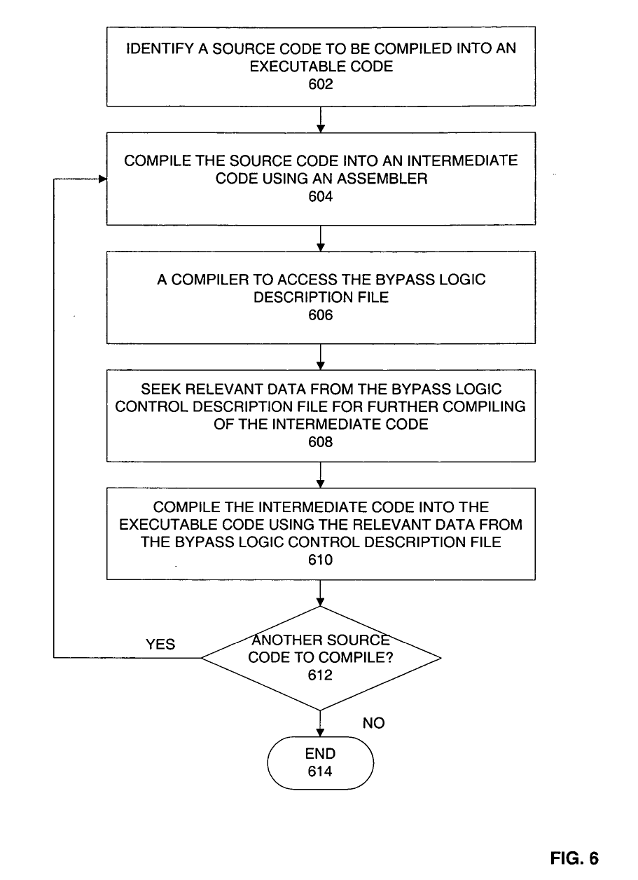

FIG. 6 is a flow diagram illustrating an embodiment of a process for using bypass logic with a compiler. First, a source code to compile into an executable code is identified at processing block 602. The source code is then compiled into an intermediate code using an assembler at processing block 604. The compiler than access the bypass logic to compile the intermediate code at processing block 606. Once the access is obtained, the compiler accesses the bypass logic description file for relevant information (e.g., status of the execution pipeline, availability of the latches, etc.) at processing block 608. The intermediate code is then compiled into the executable code by the compiler using the relevant information obtained using the bypass logic at processing block 610. At decision block 612, a determination is made as to whether there is another code to be complied. If yes, the process continues with processing block 604. If not, the process ends at termination block 614.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

While certain exemplary embodiments have been described and shown in the accompanying drawings, it is to be understood that such embodiments are merely illustrative of and not restrictive, and that the embodiments of the present invention are not to be limited to specific constructions and arrangements shown and described, since various other modifications may occur to those ordinarily skilled in the art upon studying this disclosure.

What is claimed is:

1. A method, comprising:
translating a source code into an intermediate code;
accessing a bypass control logic description file to lookup description information; and
compiling the intermediate code into an executable code using the description information.

2. The method of claim 1, wherein the translating of the source code is performed by an assembler including a Java assembler.

3. The method of claim 1, wherein the compiling of the intermediate code is performed by a compiler including a Just-in-Time (JIT) compiler.

4. The method of claim 1, wherein the bypass control logic description file resides at bypass control logic, the bypass control logic is exposed to the compiler and to a plurality of execution pipelines.

5. The method of claim 1, wherein the description information comprises information relating to one or more of the following: status of each of the plurality of execution pipelines, execution status of one or more instructions in each of the plurality of execution pipelines, and availability status of one or more latches coupled with each of the plurality of execution pipelines.

6. The method of claim 5, wherein each of the plurality of execution pipelines includes one or more execution units coupled with the one or more latches to execute the one more instructions.

7. The method of claim 1, wherein the compiling of the intermediate code further comprises generating a transformed code to schedule execution of the one or more instructions using the description information, wherein the using of the description information includes providing an address in each of the plurality of execution pipelines from where relevant data can be accessed.

8. The method of claim 4, further comprising assigning a bit to each of register source and register destination to indicate whether the register source and the register destination are register file-based or bypass control logic-based.

9. A processor, comprising:
a plurality of execution pipelines, wherein each of the plurality of execution pipelines are exposed to a bypass control logic associated with a bypass control logic destination file having description information relating to the plurality of execution pipelines; and
the bypass control logic exposed to a compiler, the compiler to access the destination file to perform a lookup of the description information to be used in facilitating compilation of a programming code.

10. The processor of claim 9, wherein the compiling of the of the programming code comprises:
translating a source code into an intermediate code using an assembler, the assembler including a Java assembler; and
compiling the intermediate code into an executable code using a compiler, the compiler including a Just-in-Time (JIT) compiler.

11. The processor of claim 9, wherein the description information comprises information relating to one or more of the following: status of each of the plurality of execution pipelines, execution status of one or more instructions in each of the plurality of execution pipelines, and availability status of one or more latches coupled with each of the plurality of execution pipelines.

12. The processor of claim 11, wherein each of the plurality of execution pipelines includes one or more execution units coupled with the one or more latches to execute the one more instructions.

13. The processor of claim 10, wherein the compiling of the intermediate code further comprises generating a transformed code to schedule execution of the one or more instructions using the description information, wherein the using of the description information includes providing an address in each of the plurality of execution pipelines from where relevant data can be accessed.

14. A system, comprising
a processor having a plurality of execution pipelines, wherein each of the plurality of execution pipelines are exposed to a bypass control logic having a bypass control logic destination file, the destination file having description information relating to the plurality of execution pipelines;
the bypass control logic in exposed to a compiler, the compiler to access the destination file to perform a lookup of the description information to be used in facilitating compilation of a programming code; and
a storage medium in communication with the processor and the bypass control logic, the storage medium to store the description information, wherein the storage medium includes one or more of the following: a dynamic random access memory (DRAM), a static random access memory (SRAM), and a scratched memory.

15. The system of claim 14, wherein the compiling of the of the programming code comprises:
translating a source code into an intermediate code using an assembler, the assembler including a Java assembler; and
compiling the intermediate code into an executable code using a compiler, the compiler including a Just-in-Time (JIT) compiler.

16. The system of claim 15, wherein the description information comprises information relating to one or more of the following: status of each of the plurality of execution pipelines, execution status of one or more instructions in each of the plurality of execution pipelines, and availability status of one or more latches coupled with each of the plurality of execution pipelines.

17. The system of claim 16, wherein each of the plurality of execution pipelines includes one or more execution units coupled with the one or more latches to execute the one more instructions.

18. The system of claim 15, wherein the compiling of the intermediate code further comprises generating a transformed code to schedule execution of the one or more instructions using the description information, wherein the using of the description information includes providing an address in each of the plurality of execution pipelines from where relevant data can be accessed.

19. A machine-readable medium having stored thereon data representing sets of instructions which, when executed by a machine, cause the machine to:
translate a source code into an intermediate code;
access a bypass control logic description file to lookup description information; and
compile the intermediate code into an executable code using the description information.

20. The machine-readable medium of claim 19, wherein the translating of the source code is performed by an assembler including a Java assembler.

21. The machine-readable medium of claim 19, wherein the compiling of the intermediate code is performed by a compiler including a Just-in-Time (JIT) compiler.

22. The machine-readable medium of claim 19, wherein the bypass control logic description file resides at bypass control logic, the bypass control logic is exposed to the compiler and to a plurality of execution pipelines.

23. The machine-readable medium of claim 19, wherein the description information comprises information relating to one or more of the following: status of each of the plurality of execution pipelines, execution status of one or more instructions in each of the plurality of execution pipelines, and availability status of one or more latches coupled with each of the plurality of execution pipelines.

24. The machine-readable medium of claim 23, wherein each of the plurality of execution pipelines includes one or more execution units coupled with the one or more latches to execute the one more instructions.

25. The machine-readable medium of claim 19, wherein the compiling of the intermediate code further comprises generating a transformed code to schedule execution of the one or more instructions using the description information, wherein the using of the description information includes providing an address in each of the plurality of execution pipelines from where relevant data can be accessed.

26. The machine-readable medium of claim 19, wherein the sets of instructions which, when executed by the machine, further cause the machine to assign a bit to each of register source and register destination to indicate whether the register source and the register destination are register file-based or bypass control logic-based.
